(19) United States
(12) Patent Application Publication
(10) Pub. No.: US 2014/0242532 A1
(43) Pub. Date: Aug. 28, 2014

(54) METHOD FOR ORTHODONTIC TREATMENT

(71) Applicant: Airton Arruda, Ann Arbor, MI (US)

(72) Inventor: Airton Arruda, Ann Arbor, MI (US)

(21) Appl. No.: 14/269,255

(22) Filed: May 5, 2014

Related U.S. Application Data
(63) Continuation-in-part of application No. 13/759,273, filed on Feb. 5, 2013, now abandoned.
(60) Provisional application No. 61/607,517, filed on Mar. 6, 2012.

(51) Int. Cl. A61C 7/08

(52) U.S. Cl. CPC A61C 7/08
USPC 433/6

(57) ABSTRACT

A method for orthodontic treatment includes defining a plurality of incremental tooth adjustment stages. Each tooth adjustment stage includes an incremental change in an alignment of at least one tooth. The tooth adjustment stages include a final stage. For one of the stages prior to the final stage, the method includes sequentially utilizing a plurality of orthodontic appliances, each appliance having identical tooth geometries configured to the stage, wherein a final orthodontic appliance for the stage is a rigid tray configured to immobilize the tooth for a recuperation period.

### CROSS REFERENCE TO RELATED APPLICATIONS

This disclosure is a continuation-in-part of U.S. patent application Ser. No. 13/759,273 filed on Feb. 5, 2013 which claims the benefit of U.S. Provisional Application No. 61/607,517 filed on Mar. 6, 2012, both of which are hereby incorporated by reference.

### TECHNICAL FIELD

This disclosure is related to orthodontic treatment including removable orthodontic appliances.

### BACKGROUND

The statements in this section merely provide background information related to the present disclosure. Accordingly, such statements are not intended to constitute an admission of prior art.

Orthodontists utilize orthodontic appliances to provide therapeutic treatment to the teeth of a patient. Orthodontic appliances or appliances can be affixed to the teeth of the patient, for example, as embodied by wire braces retained to the teeth of the patient with dental fixtures bonded to the teeth of the patient. In the alternative, appliances can be removable devices. One exemplary removable appliance includes a rigid polymer section molded over wires configured to contact and treat the teeth of the patient. Orthodontic appliances utilizing wire or similar materials to treat the teeth of a patient are configured and/or adjusted by an orthodontic professional according to methods known in the art, for example, adjusting the appliance slightly through a series of incremental office visits, such that the teeth of the patient are adjusted slightly, for example, in position or rotation, with each sequential office visit.

Another exemplary removable appliance includes an aligner tray. According to one exemplary embodiment, an aligner tray is a formed polymer with tooth shaped cavities which fits over all or most of either the upper or lower teeth of the patient. A pair of aligner trays can be used, one fitted to the upper teeth and a second fitted to the lower teeth. According to one exemplary embodiment, the aligner tray is made of a substantially transparent plastic approximately one to three millimeters thick.

An aligner tray is based upon the pre-existing alignment and position of the teeth of the patient. The tooth shaped cavities in the aligner tray can implement small alignment and/or position changes as compared to the pre-existing alignment and position of the teeth of the patient. According to one exemplary embodiment, a series of aligner trays can be used sequentially, each tray implementing incremental changes to tooth alignment and/or position.

A dental impression is a tool utilized by orthodontic professionals to model a patient's teeth. A dental impression can be made by fitting a first soft substance to the teeth of the patient, and then making a hardened dental impression of the teeth by using the first soft substance as a mold. In one exemplary embodiment, the dental impression can be made of plaster.

An aligner tray can be made by pressure-forming a flat plastic blank over the dental impression. Pressure-forming, including using a positive pressure or a pressure greater than atmospheric pressure to press down upon a blank or using a vacuum or pressure less than atmospheric pressure to pull down upon a blank, is a technique known in the art and will not be discussed in detail herein. Pressure-forming will be used to disclose a manufacturing method herein, and it will be assumed throughout that either a positive pressure method or a vacuum method can be utilized. Pressure-forming the flat plastic blank over the dental impression results in an aligner tray being formed that fits perfectly to the dental impression. By modifying the dental impression, adjusting the teeth of the dental impression, the resulting aligner tray can include changes in alignment and/or position as compared to the teeth of the patient. According to one exemplary embodiment, a plurality of dental impressions can be formed based upon the teeth of the patient, and the orthodontic professional can remove from the dental impression the teeth that need to be adjusted. By using clay, wax, plaster, or a similar substance to relocate the removed teeth to the remainder of the impression, the orthodontic professional can model the desired changes to the patient's teeth and use the impression to create an aligner tray to create the desired effect.

### SUMMARY

A method for orthodontic treatment includes defining a plurality of incremental tooth adjustment stages. Each tooth adjustment stage includes an incremental change in an alignment of at least one tooth. The tooth adjustment stages include a final stage. For one of the stages prior to the final stage, the method includes sequentially utilizing a plurality of orthodontic appliances, each appliance having identical tooth geometries configured to the stage, wherein a final orthodontic appliance for the stage is a rigid tray configured to immobilize the tooth for a recuperation period.

### BRIEF DESCRIPTION OF THE DRAWINGS

One or more embodiments will now be described, by way of example, with reference to the accompanying drawings, in which:

FIG. 1 illustrates an exemplary orthodontic appliance being applied to the teeth of a patient, in accordance with the present disclosure;

FIG. 2 illustrates an exemplary aligner tray including retention features, in accordance with the present disclosure;

FIG. 3 illustrates an exemplary aligner tray including retention features located to the teeth of a patient, in accordance with the present disclosure;

FIGS. 4A and 4B illustrate one exemplary method to provide orthodontic treatment, the method including a plurality of appliances created based upon a single treatment stage, in accordance with the present disclosure;

FIG. 4A illustrates a series of orthodontic appliances and corresponding tooth adjustment stages;

FIG. 4B illustrates tooth positions through use of the various orthodontic appliances of FIG. 4A;

FIG. 4C illustrates an exemplary tooth adjustment stage using a first tray made of thinner material and a second tray made of a thicker material, in accordance with the present disclosure;

FIG. 5 illustrates a second exemplary method to provide orthodontic treatment, the method including a plurality of appliances created based upon a single treatment stage, in accordance with the present disclosure;

FIG. 6 illustrates exemplary retention features located to a dental impression including an adhering agent applied to the dental impression proximate to the retention features in preparation for a pressure-forming process, in accordance with the present disclosure;

FIG. 7 illustrates an exemplary thin-wall aligner tray with a wall deformed some distance, in accordance with the present disclosure;

FIG. 8 illustrates an exemplary thick-wall aligner tray with a wall deformed some distance, in accordance with the present disclosure;

FIG. 9 illustrates an exemplary thin-wall aligner tray interacting with a patient's tooth that needs to be moved, in accordance with the present disclosure;

FIG. 10 illustrates an exemplary thick-wall aligner tray interacting with a patient's tooth that needs to be moved, in accordance with the present disclosure; and

FIG. 11 illustrates an exemplary method to utilize patient-removable appliances through a series of tooth adjustment stages, wherein the stages include a first thin-walled tray with a retention feature and a second thick-walled tray for each stage, in accordance with the present disclosure;

FIG. 12 illustrates an exemplary embodiment of a method for orthodontic treatment including use of retainer-gage materials for portions of the treatment, in accordance with the present disclosure; and

FIG. 13 illustrates in cross-section exemplary orthodontic trays that can be utilized according to the orthodontic treatment plan of FIG. 12, in accordance with the present disclosure.

### DETAILED DESCRIPTION

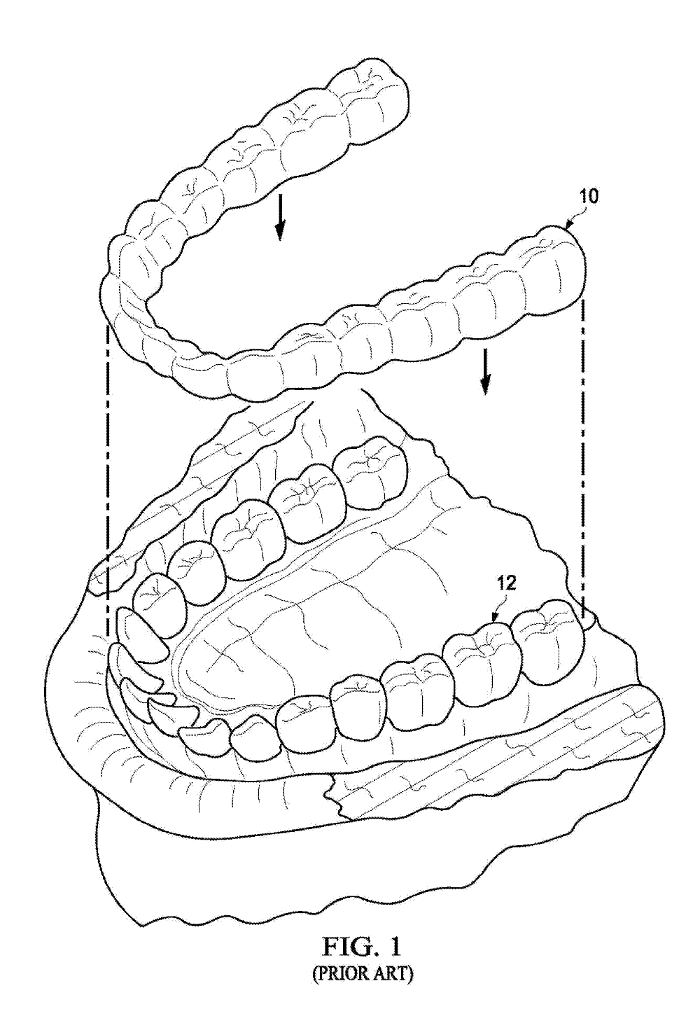

Referring now to the drawings, wherein the showings are for the purpose of illustrating certain exemplary embodiments only and not for the purpose of limiting the same, FIG. 1 illustrates an exemplary orthodontic appliance being applied to the teeth of a patient. Exemplary aligner tray 10 is illustrated in position to be applied to teeth 12 of a patient. Features in the aligner tray apply pressure to teeth 12 in order to realign the teeth according to a prescribed treatment plan of an orthodontic professional. Aligner tray 10 is illustrated, although a number of different similar patient-removable orthodontic appliances are envisioned for use in method disclosed herein, and the disclosure is not intended to be limited to the exemplary embodiments provided.

A tooth is connected to surrounding bone with periodontal ligaments (PDL). PDLs fill a gap of approximately 0.2 to 0.4 mm between the tooth and the surrounding bone. Orthodontic practices to move teeth are known to compress the PDLs on one side of a tooth. Pressure applied to the tooth to compress the PDLs can vary from a low pressure close to a blood pressure value to a high pressure exemplified by a 500 gram force on the tooth. The compressed ligament becomes necrotic tissue, which is removed by osteoclasts and over time new PDLs are formed. On the other side of the tooth, osteoblasts create new bone in the gap created by moving the teeth. By either slowly and steadily moving the teeth or by moving the teeth in small increments, this process can be used to reposition the teeth upon the alveolar bone of a patient.

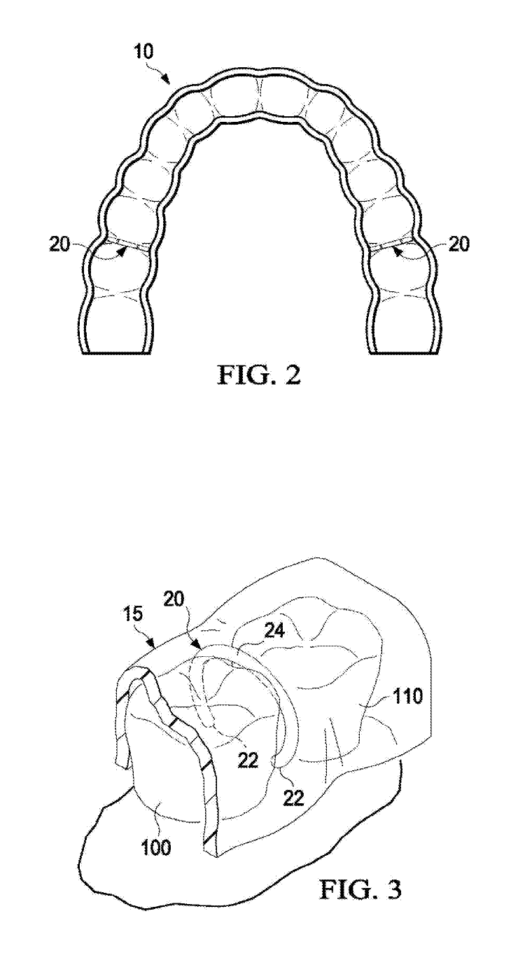

FIG. 2 illustrates an exemplary aligner tray including retention features. Aligner tray 10 is formed to the shape of one of a patient's top teeth or bottom teeth. Aligner tray 10 includes a series of tooth-shaped cavities configured to receive corresponding teeth of the patient. Aligner tray 10 includes at least one retention feature or embodied as a retention clip 20 aligned to grasp the patient's teeth. Use of a retention feature such as retention clip 20 is disclosed in co-pending application Ser. No. 13/327,469 entitled APPARATUS FOR ORTHODONTIC ALIGNER TRAY RETENTION, which is hereby incorporated by reference. A plurality of retention clips 20 can be used, aligned to a plurality of spaces between a patient's teeth. FIG. 2 illustrates an embodiment wherein two retention clips 20 are located symmetrically upon the aligner tray 10 or located at substantially identical locations on left and right sides of the aligner tray 10. In another embodiment, a different number of retention clips can be used in non-symmetrical locations upon the aligner tray. The retention clips 20 illustrated in FIG. 2 are each located between teeth toward the rear of the mouth. One having skill in the art would appreciate that the exemplary illustrated retention clips 20 are located between molars of the patient, however, retention clips can be used at various locations between different teeth and still be within the scope of the present disclosure. A location of a retention clip 20 can be equivalently described as being located between teeth of the patient and being located between tooth-shaped cavities on the aligner tray 10.

A retention feature can be made of a number of different materials, including a metal wire or a plastic or polymer material. A metal wire used as a retention feature can be made of a metal or an alloy including materials known in the art for use in a patient's mouth.

In one embodiment, retention clip 20 includes a C-shaped clip configured to fit between two of the tooth shaped cavities, such that when the aligner is placed upon the teeth of the patient, the C-shaped clip fits to the space between two of the patient's teeth, with the clip ends forming the open end of the C lightly contacting the two teeth forming the space near the bases of the teeth proximate to the patient's gums. The rest of the C-shaped is oriented to the space between the teeth, such that the closed end of the C extends above the crests of the teeth directly above the space between the teeth.

FIG. 3 illustrates an exemplary aligner tray including retention features located to the teeth of a patient. Section 15 of aligner tray 10 is illustrated including retention clip 20 placed upon patient's tooth 100 and tooth 110. Retention clip 20 includes two clip ends 22 which point inward and are configured to the geometry of the space between tooth 100 and tooth 110. Retention clip 20 is aligned to the space between tooth 100 and tooth 110, such that clip ends 22 lightly contact each of tooth 100 and tooth 110, providing a gripping force, retaining aligner tray 10 to the teeth of the patient. Closed end 24 of retention clip 20 extends above tooth 100 and tooth 110 and attaches to aligner tray 10.

A retention feature needs to be attached to aligner tray 10. In one embodiment, wherein aligner tray 10 is manufactured from a liquid plastic material, such as in an injection molding process, the retention feature can be set within the aligner tray as the tray is created. In another embodiment, wherein aligner tray 10 is manufactured from a solid blank, such as in a pressure-forming process, an adhering agent can be used to attach the retention feature to aligner tray 10.

Treatment with an orthodontic appliance can include a number of exemplary methods. For example, when only a minor adjustment to the alignment of the patient's teeth is required, a single appliance with an unchanged geometry can be used to make the adjustment. Orthodontic practices include moving teeth through more significant adjustments by incrementally moving the teeth. Wire braces are used in orthodontics, wherein a patient is brought in over a number of office visits, and the geometry of the braces are changed slightly in each visit. Over the course of a number of visits, the teeth of the patient are slowly and incrementally realigned toward a desired or final alignment.

Patient removable appliances can similarly be used to treat the alignment of the patient's teeth. Wherein substantial changes in the position or rotation of one or more teeth are required, the geometry of the applied appliances can be changed. Wherein the appliance includes wires in contact with the teeth and applying the therapeutic forces, small adjustments to the wires can be made over a series of office visits. Wherein the appliance includes a device with rigid features acting upon the teeth such as an aligner tray, a series of appliances with incrementally changing features on the appliances can be utilized. In an exemplary series of aligner trays, geometry of the impressions of the teeth can be altered through the series, with incremental changes in the geometry affecting incremental changes in the alignment of the patient's teeth. Alternatively or additionally, changes can be made to other properties of the appliance. A thickness of a plastic tray can be changed through a series of trays to change how much the tray flexes as it interacts with the teeth. A geometry, configuration, number, position, or other characteristics of retention features included on the appliance can be changed through a series of trays to change how forces are applied to the teeth.

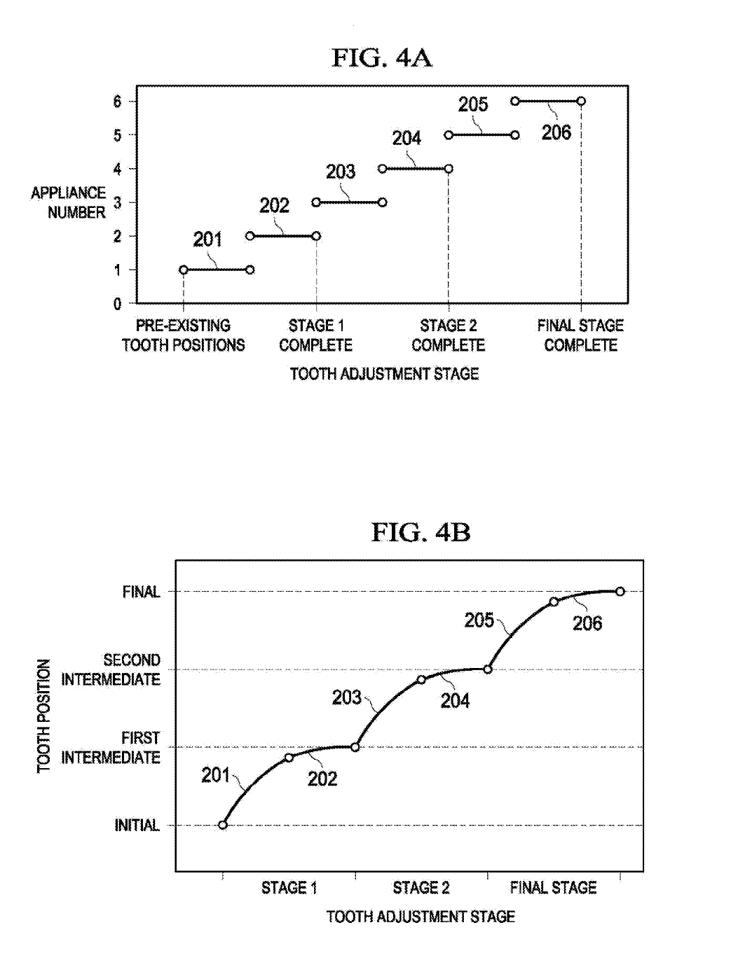

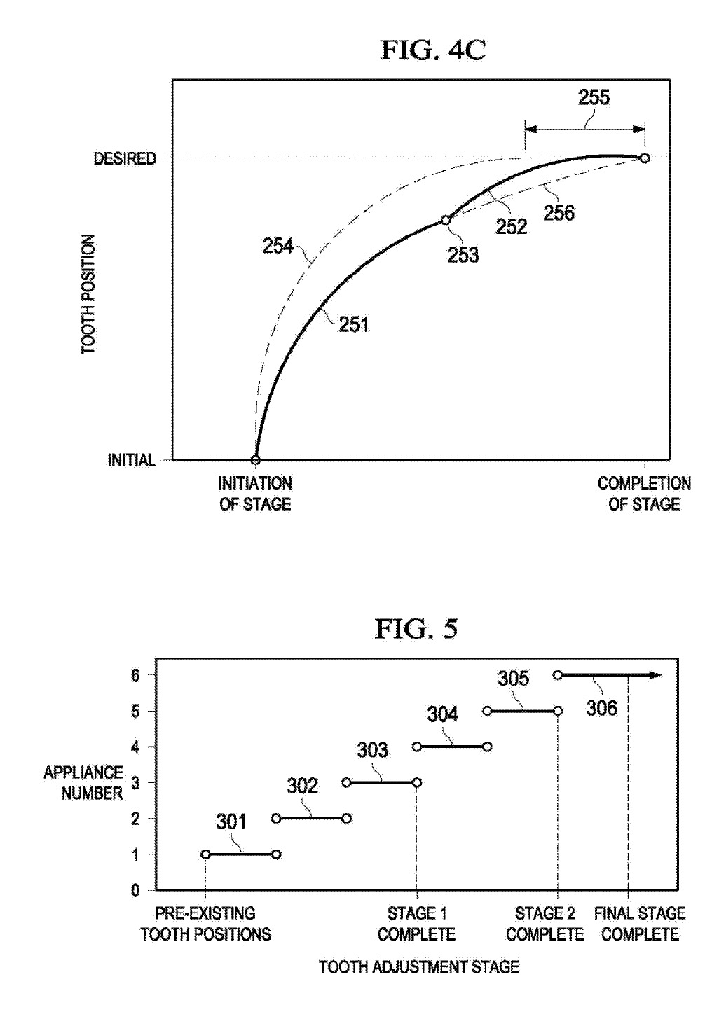

A series of patient-removable appliances can each include changes to the geometry of impressions of teeth in the tray. However, therapeutic benefits can be realized by defining incremental stages of treatment or tooth adjustment stages, each stage including incremental changes in tooth positions and/or rotations, and utilizing a plurality of trays with similar or identical tooth geometries during one or more of the adjustment stages. FIG. 4A illustrates an exemplary method to utilize patient-removable appliances through a series of tooth adjustment stages, wherein the stages include a plurality of appliances for each stage. The horizontal axis illustrates a series of stages of tooth adjustments, including an initial pre-existing tooth position, a stage 1, a stage 2, and a final stage. Incremental changes in tooth positions are implemented for each of stage 1, stage 2, and the final stage. The vertical axis illustrates a currently used appliance for any value on the horizontal axis. At the initial pre-existing tooth position, a first tray is utilized during illustrated span 201. This first tray has tooth geometries or features configured to adjust the positions and/or rotations of the teeth of the patient to an incremental alignment selected for stage 1. Tooth alignments at each stage are selected or configured according to methods known to orthodontic professionals. At some time before the completion of stage 1, a second tray with tooth impression geometries identical to the tooth impression geometries of the first tray is utilized during illustrated span 202. At the completion of stage 1, a third tray is utilized during illustrated span 203, with tooth impression geometries or features configured to adjust the positions and/or rotations of the teeth of the patient to an incremental alignment selected for stage 2. At some time before the completion of stage 2, a fourth tray with tooth impression geometries identical to the tooth impression geometries of the third tray is utilized during illustrated span 204. At the completion of stage 2, a fifth tray is utilized during illustrated span 205, with tooth impression geometries or features configured to adjust the positions and/or rotations of the teeth of the patient to an incremental alignment selected for the final stage. At some time before the completion of the final stage, a sixth tray with tooth impression geometries identical to the tooth impression geometries of the fifth tray is utilized during illustrated span 206. Any number of stages can be implemented, and any number of trays can be used during a particular stage.

FIG. 4B illustrates the tooth adjustment stages of FIG. 4A including exemplary tooth positions during the tooth adjustment stages, in accordance with the present disclosure. The horizontal axis illustrates stage 1, stage 2, and the final stage of tooth adjustment illustrated in FIG. 4B. The horizontal axis can include increments of time, days, weeks, incremental time of trays being within a patient's mouth or any other increment illustrating progression of a treatment plan. The vertical axis illustrates tooth positions throughout the stages of tooth adjustments. Spans 201 through 206 are illustrated, each corresponding to one of at least six trays used to adjust the tooth positions. Spans 201 and 202 correspond to tooth adjustment stage 1. Spans 203 and 204 correspond to tooth adjustment stage 2. Spans 205 and 206 correspond to the final tooth adjustment stage. At an initiation of each tooth treatment stage, a tray is applied to the mouth of the patient with tooth cavities in corresponding to a desired change in the tooth positions. The tray applies pressure to the teeth of the patient, and the tooth positions rapidly begin to change. Pressure applied by the tray is caused by the tray flexing from a relaxed position to a displaced position related to the teeth pressing against the tray. Pressure applied by the tray is at a maximum at the beginning of a treatment stage as the tray flex or tray displacement is at a maximum. As the teeth move to the desired position corresponding to the tooth cavities in the tray, the flex of the tray decreases, and the corresponding pressure upon the teeth decreases. As the pressure upon the teeth for a particular tray decreases, the movement of the tooth typically slows.

Pressure upon the teeth a given amount of flex of the tray depends upon the properties of the tray being used to treat the patient. Thicker trays or trays made of more resilient or rigid material apply more pressure to a tooth for a given displacement or a given amount of flex as compared to a thinner or a tray made of more pliant material. FIG. 4C illustrates an exemplary tooth adjustment stage using a first tray made of thinner material and a second tray made of a thicker material. The horizontal axis illustrates a single tooth adjustment stage. The vertical axis illustrates tooth positions through the tooth adjustment stage. Span 251 illustrates a period during which a first, more pliable tray is utilized. Because the tray is pliable, a relatively small pressure is applied to the tooth in relation to the patent's teeth causing the tray to flex. As a result, the tooth position changes at a relatively slow rate corresponding to the relatively small pressure being applied to the tooth. Span 254 is illustrated showing how the tooth position would change if a more rigid tray were used at the initiation of the stage. One having skill in the art will appreciate that, according to orthodontic practices, tooth positions can only be changed at certain rates, and exceeding a maximum rate of tooth position change can be detrimental to the patient. For a given difference between tooth cavity locations on a tray and actual tooth positions in the patient's mouth, a more pliant tray associated with span 251 can be used to move teeth more gradually that would a more rigid tray associated with span 254. Once the teeth of the patient have moved a portion of the way to a desired tooth position, transition 253 can be performed, wherein a second tray associated with span 252 can be substituted for the first tray. By the time transition 253 occurs, the tooth positions have changed a substantial portion of the total position change between the initial position and the desired position, and further the rate of change in tooth position has slowed significantly as compared to the rate of change when the first tray was first utilized. The second tray associated with span 252, including the same tooth cavities as the first tray but utilizing a more rigid tray, can be capable of applying greater pressure upon the patient's teeth for a given difference between the tooth cavity locations and the tooth positions. Therefore, span 252 illustrates that the tooth position more quickly approaches the desired tooth position than would the first tray, if it were simply continued to be used, as illustrated by span 256. Because the second tray quickly brings the tooth position to or near the desired tooth location, a period 255 of stable tooth position is realized with the use of the second tray, where continued use of the first tray would continue to include relatively unstable tooth movement as the tooth position continued to slowly approach the desired tooth position. A tooth treatment plan using only the first tray would require a longer total tooth adjustment stage to permit the time required for the tooth to move between adjustment stages as compared to the illustrated treatment plan including spans 251 and 252. A treatment plan requiring more intermediate positions, for example, including different tooth cavity configurations for each of the trays, would be more costly to produce, require complicated modeling of the many intermediate stages, and does not include an accelerated approach to a desired tooth position as is illustrated by the second tray and span 252 of FIG. 4C. As a result of the disclosed method, a series of trays using a single set, version, or stage of tooth cavities representing desired tooth positions for the single stage of tooth adjustment can be used to quickly bring the tooth positions to the desired tooth positions and provide a period of tooth stabilization that a single tray with fixed properties would not be able to provide.

Tooth adjustment stages can take different lengths of time, depending upon factors specific to a patient. Such lengths of time can be selected according to skills of an orthodontic professional. According to one exemplary embodiment, typical tooth adjustment stages can each last three to five weeks.

FIG. 5 illustrates an exemplary method to utilize patient-removable appliances through a series of tooth adjustment stages, wherein the stages include various numbers of appliances for each stage. The horizontal axis illustrates a series of stages of tooth adjustments, including an initial pre-existing tooth position, a stage 1, a stage 2, and a final stage. Incremental changes in tooth positions are implemented for each of stage 1, stage 2, and the final stage. The vertical axis illustrates a currently used appliance for any value on the horizontal axis. At the initial pre-existing tooth position, a first tray is utilized during illustrated span 301. This first tray has tooth geometries or features configured to adjust the positions and/or rotations of the teeth of the patient to an incremental alignment selected for stage 1. Tooth alignments at each stage are selected or configured according to methods known to orthodontic professionals. At some time before the completion of stage 1, a second tray with tooth impression geometries identical to the tooth impression geometries of the first tray is utilized during illustrated span 302 and a third tray with tooth impression geometries identical to the tooth impression geometries of the first tray is utilized during illustrated span 303. At the completion of stage 1, a fourth tray is utilized during illustrated span 304, with tooth impression geometries or features configured to adjust the positions and/or rotations of the teeth of the patient to an incremental alignment selected for stage 2. At some time before the completion of stage 2, a fifth tray with tooth impression geometries identical to the tooth impression geometries of the fourth tray is utilized during illustrated span 305. At the completion of stage 2, a sixth tray is utilized during illustrated span 306, with tooth impression geometries or features configured to adjust the positions and/or rotations of the teeth of the patient to an incremental alignment selected for the final stage. The sixth tray can be used until the completion of the final stage. In the alternative, as illustrated in FIG. 5, the sixth tray can continued to be used by the patient as a retainer device past the completion of the final stage. Any number of stages can be implemented, and any number of trays can be used during a particular stage.

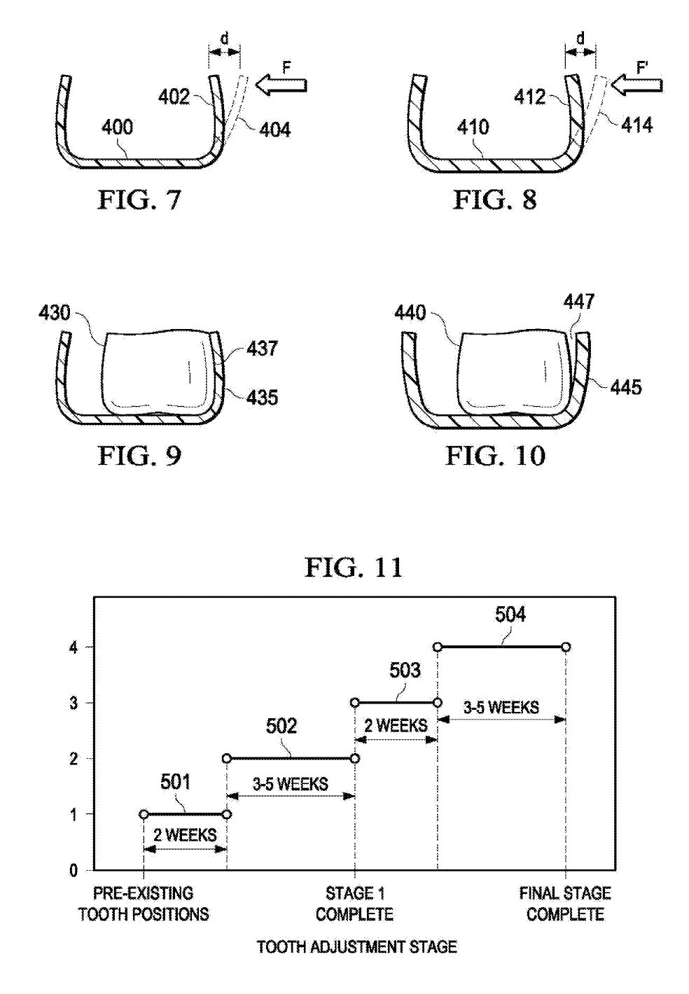

A plurality of orthodontic appliances can be utilized for a single stage of treatment to a particular tooth position. Properties of a particular tray and the effects that the tray has upon the patient can be modulated by using trays with different properties. Each of the plurality of trays used in a stage of treatment corresponding to a desired tooth position can be selected with different properties. FIG. 7 illustrates an exemplary thin-wall aligner tray with a wall deformed some distance. A thin-wall tray tends to be more flexible than a comparably thicker tray. Tray 400 is shown in cross section, wherein the vertical sides of tray 400 would match vertical sides of a tooth inserted within the tray, and the horizontal section of tray 400 would match the flat portion of the crown or the cuspal of the tooth inserted. A vertical side of the tray is shown in a resting position 402. The same vertical side is also shown in a flexed position 404, displaced from the resting position 402 by some distance d. Flexing tray 400 from resting position 402 results in an elastic force F, which would be applied to any tooth in contact with tray 400.

FIG. 8 illustrates an exemplary thick-wall aligner tray with a wall deformed some distance. A thick-wall tray tends to be more rigid than a comparably thinner tray. Tray 410 is shown in cross section, wherein the vertical sides of tray 410 would match vertical sides of a tooth inserted within the tray, and the horizontal section of tray 410 would match the flat portion of the crown or the cuspal of the tooth inserted. A vertical side of the tray is shown in a resting position 412. The same vertical side is also shown in a flexed position 414, displaced from the resting position 412 by some distance d. Flexing tray 400 from resting position 402 results in an elastic force F′ which would be applied to any tooth in contact with tray 400. Because the thick-wall tray 410 of FIG. 8 tends to be more rigid than the thin-wall tray of FIG. 7, F′ will tend to be a larger force than F.

FIG. 9 illustrates an exemplary thin-wall aligner tray interacting with a patient's tooth that needs to be moved. Thin-wall tray 435 is shown interacting with tooth 430. Tray 435 is aligned to tooth 430 to provide an elastic force upon the illustrated right side of tooth 430 to move it in a left direction upon the figure. Because tray 435 includes a more flexible material than would a comparably thick-walled tray, tray 435 is more likely to conform to the shape of the tooth and be able to provide distributed pressure to the side of the tooth than would a tray only making limited contact with the tooth. Distributed pressure along the side of the tooth can be more likely to move the tooth generally to the left, whereas limited contact or point contact at the corner of the tooth can be more likely to move and turn the tooth. The exemplary tray 435 is illustrated in solid contact in area 437 along the vertical side of the tooth.

FIG. 10 illustrates an exemplary thick-wall aligner tray interacting with a patient's tooth that needs to be moved. Thick-wall tray 445 is shown interacting with tooth 440. Tray 445 is aligned to tooth 440 to provide an elastic force upon the illustrated right side of tooth 440 to move it in a left direction upon the figure. Because tray 445 includes a more rigid material than would a comparably thick-walled tray, tray 445 is more likely to retain its natural shape and include a gap 447 between tray 445 and tooth 440.

FIGS. 7-10 illustrate and disclose thin-walled trays and thick-walled trays. A number of tray thicknesses can be used, and the disclosed properties can vary by degree with selected wall thicknesses. One having skill in the art will appreciate that different polymer materials can similarly alter properties such as flexibility, wherein two trays with similar thicknesses can have different properties based upon the particular polymer selected. A number of different tray configurations, thicknesses, material types, and other tray properties are envisioned and can be changed for different trays in a treatment plan, and the disclosure is not intended to be limited to the particular examples provided herein. In one example, a first tray with a material thickness and rigidity can be utilized, and a second tray with the same material thickness and rigidity can be used, wherein the position and/or shape of the retention features utilized for the trays can be different. In another example, a tray with a special coating or treatment can be used in one of a series of trays for stage of tooth adjustment.

Any series of tray configurations selected based upon particular tray properties can be used in any stage of treatment. FIG. 11 illustrates an exemplary method to utilize patient-removable appliances through a series of tooth adjustment stages, wherein the stages include a first thin-walled tray with a retention feature and a second thick-walled tray for each stage. The horizontal axis illustrates a series of stages of tooth adjustments, including an initial pre-existing tooth position, a stage 1, and a final stage. Incremental changes in tooth positions are implemented for each of stage 1 and the final stage. The vertical axis illustrates a currently used appliance for any value on the horizontal axis. At the initial pre-existing tooth position, a first tray is utilized during illustrated span 501. This first tray has tooth geometries or features configured to adjust the positions and/or rotations of the teeth of the patient to an incremental alignment selected for stage 1. Tooth alignments at each stage are selected or configured according to methods known to orthodontic professionals. The first tray utilized during span 501 with a comparably thin wall is more flexible than a comparably thick wall. The first tray applies a force to a patient's tooth or teeth, and the teeth move over time to the positions selected for stage 1. By using a flexible tray with retention feature such as a pair of exemplary retaining clips locating the tray to the teeth, the flexible tray can apply a more gentle force upon the teeth, remain in close contact with the teeth, and be positively located to the teeth with the retention feature. At some time after the teeth stop moving and before the completion of stage 1, a second tray with tooth impression geometries identical to the tooth impression geometries of the first tray with a thicker wall is utilized during illustrated span 502. The teeth are already moved to the positions and/or orientations selected for stage 1, however, retaining the teeth in the positions associated with stage 1 before moving to a new stage can be beneficial. A more rigid tray utilized during span 502 can aid in firmly holding the teeth in the new positions, for example, resisting tooth movement during the chewing of food, and allowing the process of new PDLs and bone forming to quietly proceed before the next stage is initiated. At the completion of stage 1, a third tray is utilized during illustrated span 503, with tooth impression geometries or features configured to adjust the positions and/or rotations of the teeth of the patient to an incremental alignment selected for the final stage. The third tray can include a similar wall thickness and retention features as the first tray. By using a flexible tray with retention feature such as a pair of exemplary retaining clips locating the tray to the teeth, the flexible tray can apply a more gentle force upon the teeth, remain in close contact with the teeth, and be positively located to the teeth with the retention feature. At some time after the teeth stop moving and before the completion of the final stage, a fourth tray with tooth impression geometries identical to the tooth impression geometries of the third tray is utilized during illustrated span 504. The fourth tray can include a similar wall thickness and serve a similar function to the second tray. Spans 501 and 503, wherein more flexible trays are utilized to move the teeth of the patient, are each illustrated to last an exemplary period of two weeks. Spans 502 and 504, wherein more rigid trays are utilized to retain the positions of the teeth before the completion of the present stage, are each illustrated to last an exemplary period of three to five weeks. These treatment periods are exemplary, however, a orthodontic professional can adjust these periods as professionally necessary. FIG. 11 provides a non-limiting example of tray thicknesses and retention features that may be used according to disclosed methods. Any number of stages can be implemented, and any number of trays with varying configurations can be used during a particular stage.

Exemplary methods are known to move teeth approximately 0.10-0.20 mm for each of a series of sequential aligner trays, for example, changing the aligner trays every two weeks. By moving the teeth with a first tray and resting the teeth with a second tray as disclosed herein, the teeth can be moved by larger increments for each incremental stage, for example, moving the teeth an exemplary distance of 0.20-0.40 mm for each stage.

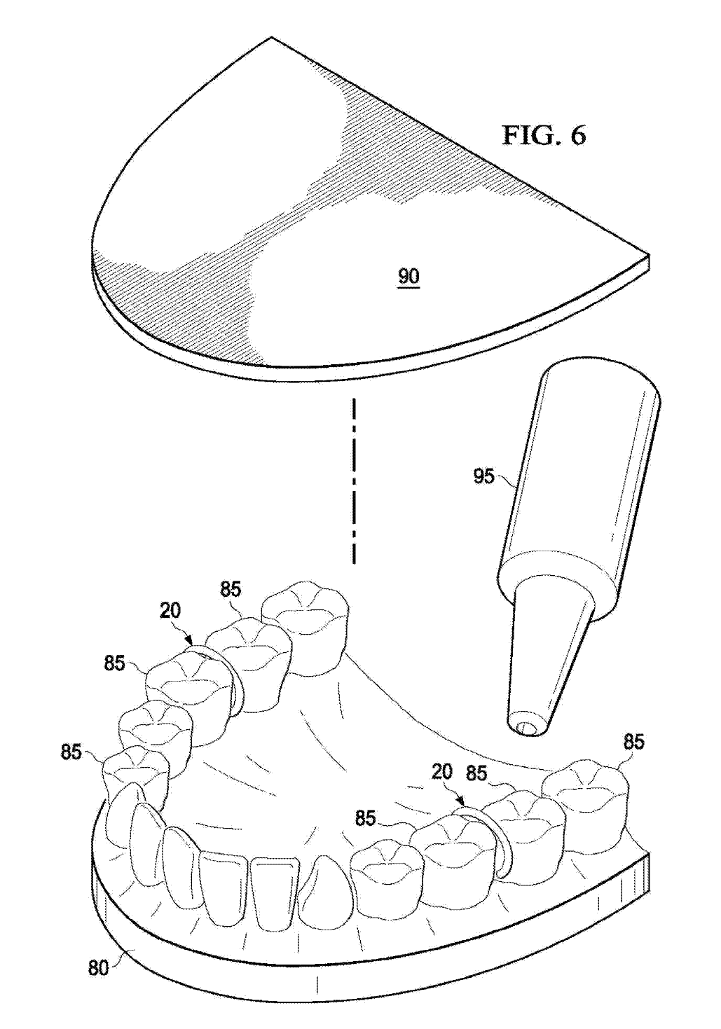

FIG. 6 illustrates exemplary retention features located to a dental impression including an adhering agent applied to the dental impression proximate to the retention features in preparation for a pressure-forming process. Dental impression 80 is a rigid physical model of a patient's teeth including a plurality of tooth features 85. Dental impression 80 is manufactured according to methods known in the art. In order to manufacture an aligner tray effective to adjust alignment and/or position of a patient's teeth, tooth features 85 can be adjusted based upon desired tooth adjustments. Dental impression 80 is located in a pressure-forming device known in the art which is configured to apply a pressure effective to form-fit a piece of polymer such as aligner tray blank 90 over a selected shape such as dental impression 80, such that a rigid plastic part is formed with cavities based upon features upon the selected shape. Using an aligner tray blank 90 to manufacture an aligner tray 10 using pressure-forming is known in the art. Retention clips 20 are each located to spaces between two tooth features 85. Retention clips 20 can be adjusted to a desired fit to the tooth features 85, adjusting size or width of the gap between the clip ends of the retention clips, according to methods known in the art. Adhering agent dispenser 95 is used to apply a measured amount of adhering agent to each of retention clip 20. An adhering agent can be selected that begins in a semi-liquid or paste form and sets to a solid over time. Additionally, an adhering agent can be selected that includes sufficient viscosity, such that being placed between dental impression 80 and aligner tray blank 90 during a pressure-forming process, the aligner tray blank 90 is formed around the adhering agent. Aligner tray blank 90 can be a thin, flat polymer sheet made of a material known in the art used in pressure-forming. In one embodiment, aligner tray blank 90 can be a clear polymer, such that the resulting aligner tray is a clear aligner tray. Aligner tray blank 90 is located to be placed over dental impression 80 and subsequently pressure formed to the dental impression 80 including the retention clips 20 and adhering agent. After the adhering agent sets, the resulting aligner tray 10 including connected retention clips 20 can be removed from the dental impression 80.

In one embodiment, a plurality of dental impressions can be utilized to create the various trays utilized for each of a number of tooth adjustment stages. For example, a first dental impression can be modified according to stage 1 of a treatment plan, and a plurality of trays can be manufactured from the modified dental impression. A second dental impression can be modified according to stage 2 of a treatment plan, and a plurality of trays can be manufactured from the second modified dental impression. Some trays may include retention features where others to not, but because all of the trays for a stage are manufactured according to a single modified dental impression, the tooth impressions in the various trays for a stage will be identical or have tooth impressions configured to a single desired tooth arrangement. By using a single dental impression to make a plurality of trays, the trays are each configured to the stage of treatment represented in the dental impression.

Dental impressions can be made from plaster or other somewhat brittle materials. The process of making trays by pressure forming plastic over the impression can damage the impression or the materials used to adjust the tooth alignments on the impression. Methods are known in the art to make a resilient copy of the dental impressions, for example, creating a one piece plastic copy of the dental impression. One can modify a series of dental impressions, copy each of the modified impressions to create a resilient copy of the modified dental impressions, and then utilize the copies to make trays for use by the patient.

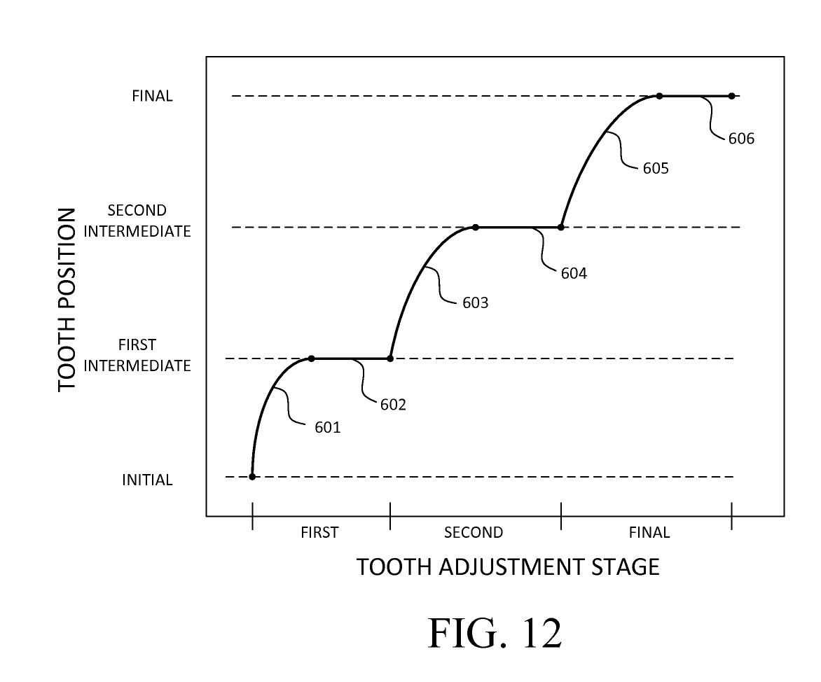

FIG. 12 illustrates an exemplary embodiment of a method for orthodontic treatment including use of retainer-gage materials for portions of the treatment. FIG. 12 illustrates the tooth adjustment stages of an orthodontic treatment plan similar to the plan illustrated in FIG. 4B, with a distinction that in the second portions of at least one tooth adjustment stage, a retainer device or an orthodontic tray constructed of rigid, inflexible material such as retainer gage plastic is utilized to immobilize the patient's teeth during that particular portion of the treatment plan.

Orthodontic trays made of flexible material can be embodied in a number of ways. Using orthodontic plastic materials known in the art and used commonly on orthodontic trays, a flexible tray can include thicknesses of up to 0.5 mm. An orthodontic professional can select trays within this range based upon a desired pressure that she or he wants to exert upon the teeth of the patient. Using known plastic types, any tray that is too thick or too rigid would exert too much pressure on teeth and that are not in the positions formed in the tray and would result in damage to the teeth and the underlying bone outside of the osteoblast/osteoclast formation utilized in normal orthodontic treatment.

Once teeth have been moved, testing has shown that holding the teeth immobilized for a period before advancing to a new stage and again moving the teeth can be beneficial. This recuperation period is healthier for the tooth and the surrounding bone material as the tissue is isolated for a period and permitted to heal before new pressure is applied to the teeth and the osteoblast/osteoclast formation process begins again. By using thick, retainer gage plastic trays constructed of orthodontic tray plastic known in the art, the teeth can be immobilized in the recuperation periods prior to a new treatment stage beginning. Exemplary tray thicknesses used to immobilize the teeth can include thicknesses of greater than 0.5 mm in materials that are typically used to make aligner trays. A typical thickness to firmly grip and immobilize the teeth is between 1.0 and 1.5 mm. While thickness can be modulated according to these exemplary ranges to accomplish use of flexible trays and rigid, retainer-gage trays, one having skill in the art will appreciate that the same process can be accomplished by modulating rigidity of the trays through other means, such as changing materials, reinforcing a tray with metal wires, adding reinforcement ribs, or other stiffening methods known in the art. In one exemplary treatment plan, one could use a flexible material that operates to safely move the teeth of patient at 0.3 mm thickness, and then use a second tray made of more rigid plastic also at 0.3 mm thickness as a tray to immobilize the teeth of the patient for a period. The disclosure intends to include any orthodontic treatment plan where a first flexible tray is used to move teeth, and a second tray, with rigid construction and with tooth cavities identical to the first tray, is used to implement a recuperation period prior to a next stage where third flexible tray is used to again move the patient's teeth.

The horizontal axis of FIG. 12 illustrates stage 1, stage 2, and a final stage of tooth adjustment. The horizontal axis can include increments of time, days, weeks, incremental time of trays being within a patient's mouth or any other increment illustrating progression of a treatment plan. The different stages and portions of stages can have different time spans from each other. The vertical axis illustrates tooth positions throughout the stages of tooth adjustments. Spans 601 through 606 are illustrated, each corresponding to one of six exemplary trays used to adjust the tooth positions. Spans 601 and 602 correspond to tooth adjustment stage 1. Spans 603 and 604 correspond to tooth adjustment stage 2. Spans 605 and 606 correspond to the final tooth adjustment stage. Spans 601, 603, and 605 are tooth movement periods wherein thin, flexible trays are used to move the patient's teeth from one set of positions to a next set of positions. Spans 602, 604, and 606 are recuperation periods wherein the teeth are immobilized and ideally kept motionless by rigid trays, for example, trays constructed of retainer-gage plastic.

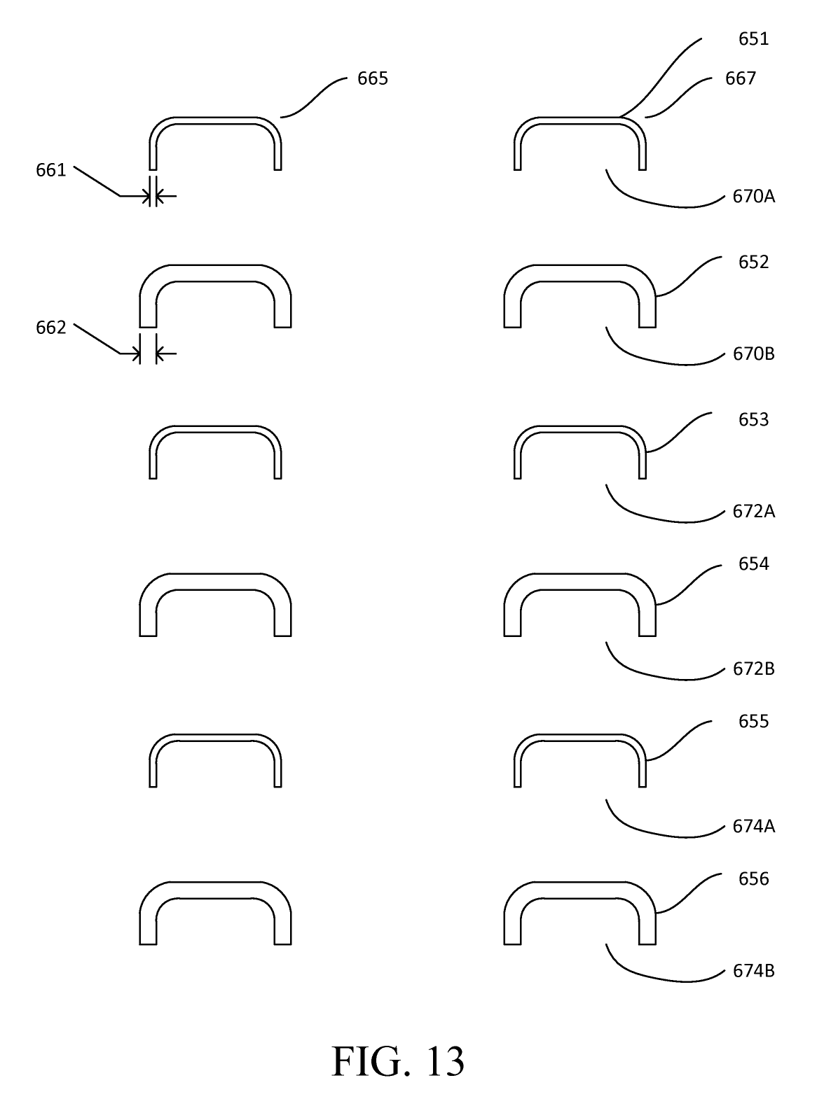

FIG. 13 illustrates in cross-section exemplary orthodontic trays that can be utilized according to the orthodontic treatment plan of FIG. 12. Six trays 651, 652, 653, 654, 655, and 656 are illustrated in cross-section, showing exemplary sections capturing molars toward a back of the mouth of the patient. First side 665 of tray 651 is illustrated ready to engage to a left side of a patient's mouth, and second side 667 of tray 651 is illustrated ready to engage to a right side of the patient's mouth. Tray 651 includes tooth cavities 670A, and tray 652 includes tooth cavities 670B. Tooth cavities 670A and tooth cavities 670B can be identical to each other. Tray 653 includes tooth cavities 672A, and tray 654 includes tooth cavities 672B. Tooth cavities 672A and tooth cavities 672B can be identical to each other. Tray 655 includes tooth cavities 674A, and tray 656 includes tooth cavities 674B. Tooth cavities 674A and tooth cavities 674B can be identical to each other. Tray 651 is illustrated with material thickness 661, a relatively thin thickness permitting tray 651 to be flexible, and tray 652 is illustrated with material thickness 662, a thick retainer-gage material, causing tray 652 to be useful to hold the patient's teeth immobilized through a recuperation period. Similarly, trays 653 and 655 can include the same or similar material thickness to thickness 661 of tray 651, and trays 654 and 656 can include the same or similar material thickness to thickness 662 of tray 652. In this way, trays 651, 653, and 655 can be used to accomplish the movement of teeth illustrated in spans 601, 603, and 605, respectively, and trays 652, 654, and 656 can be used to accomplish the recuperation periods illustrated in spans 602, 604, and 606. In other embodiments, the recuperation period can be used in only one or only a portion of tooth treatment stages, with other tooth stages using conventional treatment with a single orthodontic tray or with trays configured according to the treatment plan illustrated in FIG. 4B. In one embodiment, for a single treatment stage with a single set of tooth geometries, a first more flexible tray can be used first, a second less flexible tray can be used second, and a third rigid tray constructed of retainer-gage plastic can be used prior to the treatment plan advancing to a next stage where the teeth are to be moved again. The treatment plans of the disclosure can take many similar but distinct embodiments, and the disclosure is not intended to be limited to the particular examples provided herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An orthodontic treatment plan, comprising:
defining a plurality of incremental tooth adjustment stages, each stage including an incremental change in an alignment of at least one tooth, the tooth adjustment stages comprising a final stage; and
for one of the stages prior to the final stage, sequentially utilizing a plurality of orthodontic appliances, each appliance having identical tooth geometries configured to the stage, wherein a final orthodontic appliance for the stage is a rigid tray configured to immobilize the tooth for a recuperation period.

2. The orthodontic treatment plan of claim 1, wherein the final orthodontic appliance comprises an orthodontic appliance constructed of retainer-gage plastic.

3. The orthodontic treatment plan of claim 2, wherein the retainer-gage plastic comprises a thickness of greater than 0.5 mm.

4. The orthodontic treatment plan of claim 2, wherein the wherein the retainer-gage plastic comprises a thickness of between 1.0 mm and 1.5 mm.

5. The orthodontic treatment plan of claim 1, wherein the remainder of the plurality of orthodontic appliances for the one of the stages prior to the final stage comprises one or more flexible orthodontic appliances configured to move the tooth.

6. The orthodontic treatment plan of claim 1, further comprising, for each of the stages, sequentially utilizing a plurality of orthodontic appliances, each appliance having identical tooth geometries configured to the stage and a final appliance for each stage being configured to immobilize the tooth.

7. The orthodontic treatment plan of claim 1, wherein a final appliance used in a last tooth adjustment stage is utilized after the last tooth adjustment stage as an orthodontic retainer device.

8. The orthodontic treatment plan of claim 1, wherein the remainder of the plurality of orthodontic appliances for the one of the stages prior to the final stage comprises one or more flexible orthodontic appliances configured to move the tooth; and
wherein the appliances for the one of the stages are the same thickness and comprise appliances with different flexibilities.

9. An orthodontic treatment plan, comprising:
defining a plurality of incremental tooth adjustment stages, each stage including an incremental change in alignment a plurality of teeth, the tooth adjustment stages comprising a final stage; and
for one of the stages prior to the final stage, sequentially utilizing two orthodontic appliances, each appliance having identical tooth geometries configured to the stage, wherein the first orthodontic appliance is flexible and configured to move the teeth and wherein the second orthodontic appliance is a rigid tray configured to immobilize the tooth for a recuperation period.

10. The orthodontic treatment plan of claim 9, further comprising, for each of the stages prior to the final stage, sequentially utilizing two orthodontic appliances, each appliance having identical tooth geometries configured to the stage, wherein the first orthodontic appliance is flexible and configured to move the teeth and wherein the second orthodontic appliance is a rigid tray configured to immobilize the tooth for a recuperation period.

11. The orthodontic treatment plan of claim 9, further comprising, for each of the stages, sequentially utilizing two orthodontic appliances, each appliance having identical tooth geometries configured to the stage, wherein the first orthodontic appliance is flexible and configured to move the teeth and wherein the second orthodontic appliance is a rigid tray configured to immobilize the tooth for a recuperation period.

12. The orthodontic treatment plan of claim 9, wherein the second orthodontic appliance comprises an orthodontic appliance constructed of retainer-gage plastic.

13. The orthodontic treatment plan of claim 12, wherein the retainer-gage plastic comprises a thickness of greater than 0.5 mm.

14. The orthodontic treatment plan of claim 12, wherein the wherein the retainer-gage plastic comprises a thickness of between 1.0 mm and 1.5 mm.

15. The orthodontic treatment plan of claim 9, wherein the first appliance and the second appliance are the same thickness and comprise appliances with different flexibilities.

16. A series of orthodontic aligner trays used to adjust tooth positions in a patient, the series comprising:
for each of a plurality of tooth adjustment stages:
a first flexible aligner tray comprising a set of tooth cavities configured to the tooth adjustment stage, and
a second rigid aligner tray configured to immobilize teeth of the patient through a recuperation period and comprising the set of tooth cavities configured to the tooth adjustment stage.

17. The series orthodontic aligner trays of claim 16, wherein the second rigid aligner tray comprises an aligner tray constructed of retainer-gage plastic.

18. The orthodontic treatment plan of claim 17, wherein the retainer-gage plastic comprises a thickness of greater than 0.5 mm.

19. The orthodontic treatment plan of claim 17, wherein the wherein the retainer-gage plastic comprises a thickness of between 1.0 mm and 1.5 mm.

20. The orthodontic treatment plan of claim 16, wherein the first aligner tray and the second aligner tray are the same thickness and comprise aligner trays with different flexibilities.
